(19) United States
(12) Patent Application Publication
(10) Pub. No.: US 2012/0228447 A1
(43) Pub. Date: Sep. 13, 2012

(54) GONDOLA UPRIGHT MOUNTING DEVICE

(75) Inventors: Patrick J. Barkdoll, Pecatonica, IL (US); Thomas E. Valiulis, Rockford, IL (US)

(73) Assignee: SOUTHERN IMPERIAL, INC., Rockford, IL (US)

(21) Appl. No.: 13/042,685

(22) Filed: Mar. 8, 2011

(51) Int. Cl. A47F 5/08; F16B 45/00; F16M 13/02

(52) U.S. Cl. 248/220.22; 248/205.1; 211/59.1

(57) ABSTRACT

A mounting bracket assembly for a gondola upright that includes a mounting bracket having a mounting detail and a substantially flat portion, and a wire hanger configured to be attached to the mounting bracket. In a particular embodiment, the mounting bracket assembly wherein the mounting detail is configured to fit into an opening in the gondola upright. The mounting detail is configured to secure the mounting bracket to the gondola upright. Further, the substantially flat portion is configured to position the mounting bracket and wire hanger in a desired orientation.

### FIELD OF THE INVENTION

This invention generally relates to retail display systems, and more specifically, to retail display systems incorporating retail gondola systems.

### BACKGROUND OF THE INVENTION

Conventional retail gondola systems have been used in various configurations for mounting shelving and hooks in retail environments for years. These hooks traditionally mount within a peg board or slatwall panel insert that fits between two gondola uprights. These gondola uprights that make up the end structures of the gondola typically have a series of rectangular piercings or stamped out areas that are used by the shelves for mounting in the gondola units. There are also a number of devices that have been developed to take advantage of upright mounting systems, such as cross bars and basket systems. At times, retailers will use a mixture of display systems within a system of gondolas, shelves, cross bars and hooks to create the proper presentation of the goods for sale.

Conventional mounting hooks have been limited to being mounted between the uprights of the gondola due to the style of the hooks and where the hooks have been designed to mount. It would therefore be desirable to have a mounting hook design capable of mounting individually to a gondola upright. Embodiments of the invention provide such a mounting hook. These and other advantages of the invention, as well as additional inventive features, will be apparent from the description of the invention provided herein.

### BRIEF SUMMARY OF THE INVENTION

In one aspect, embodiments of the invention provide a mounting bracket assembly for a gondola upright that includes a mounting bracket having a mounting detail and a substantially flat portion, and a wire hanger configured to be attached to the mounting bracket. In a particular embodiment of the mounting bracket assembly, the mounting detail is configured to fit into an opening in the gondola upright. The mounting detail is configured to secure the mounting bracket to the gondola upright. Further, the substantially flat portion is configured to position the mounting bracket and wire hanger in a desired orientation.

In another aspect, embodiments of the invention provide a retail display system that includes one or more gondola uprights configured to support the retail display system, and a mounting bracket assembly capable of being mounted in a single gondola upright, the mounting bracket assembly comprising. In a particular embodiment, the mounting bracket assembly includes a mounting bracket has a mounting detail and a substantially flat portion, and a wire hook configured to be attached to the mounting bracket. In a particular embodiment, the mounting detail is configured to fit into an opening in the gondola upright. The mounting detail is configured to secure the mounting bracket to the gondola upright. Further, the substantially flat portion is configured to position the mounting bracket and wire hanger in a desired orientation.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a pictorial view of a gondola upright mounting device, according to an embodiment of the invention;

FIG. 2 is a pictorial view of a gondola upright mounting device, according to an alternate embodiment of the invention;

FIG. 3 is a pictorial view of a gondola upright mounting device, according to yet another embodiment of the invention;

FIG. 4 is a pictorial view of a gondola upright mounting device, according to yet another embodiment of the invention; and

FIG. 5 is a pictorial view of a gondola upright incorporating the mounting devices of FIGS. 1-3.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

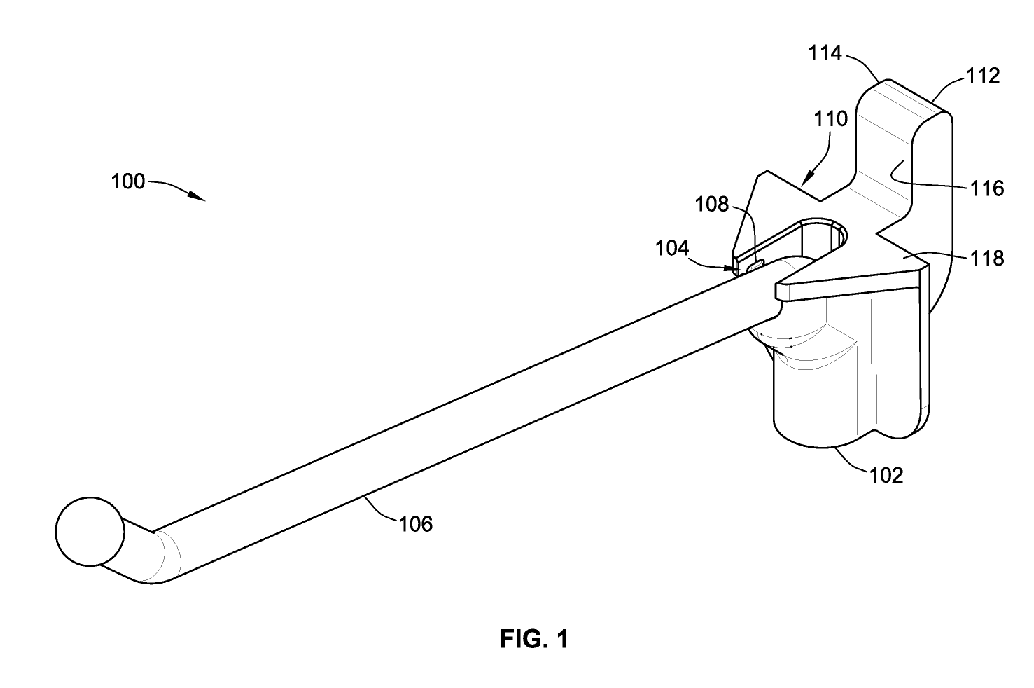

FIG. 1 is a pictorial illustration of a mounting bracket assembly 100, according to an embodiment of the invention. The mounting bracket assembly 100 includes a mounting bracket 102 designed with a specific contour 104 for the insertion of the wire hook 106 including snap points 108 to offer resistance to keep the wire hook 106 from being removed from the mounting bracket 102. Rather than having a round hole to accept one end of the wire hook 106, the specific contour 104 has multiple flats that make contact with the wire hook 106 to aid in the fit of the wire hook 106 to the mounting bracket 102.

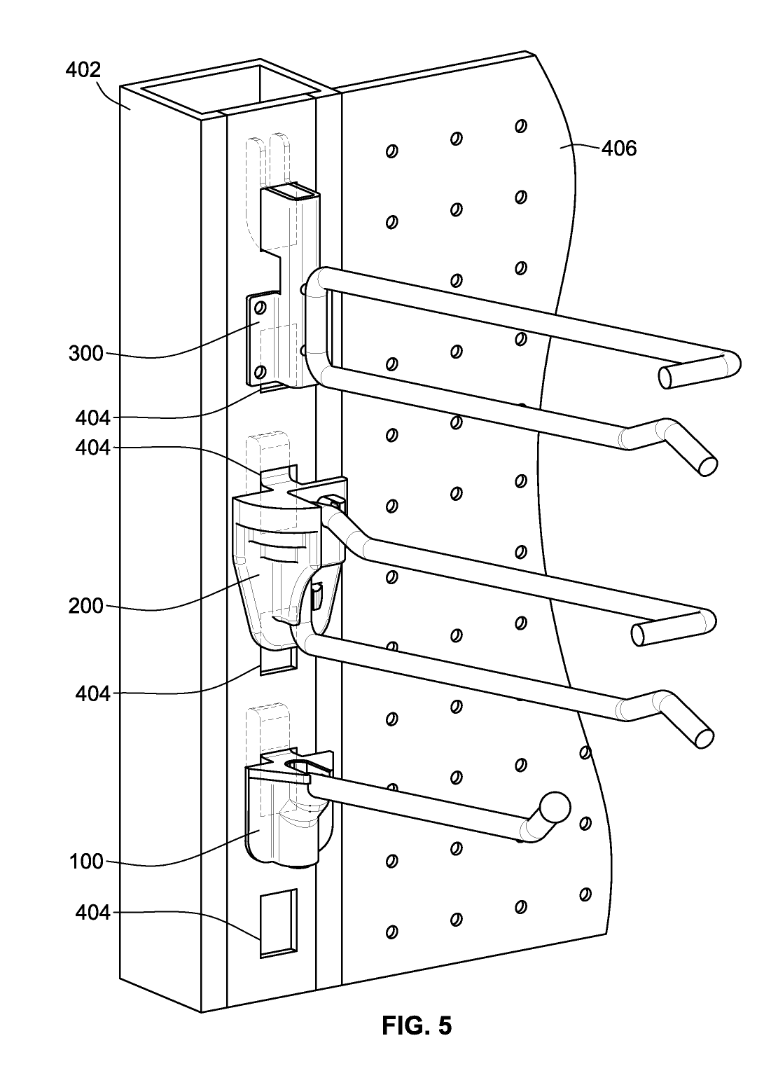

The mounting bracket 102 is designed to maintain an even wall thickness where it can, to avoid sinking and deforming from oversized walls. Behind the mounting area for the wire hook 106 is a flat surface 110 that will come in contact with the gondola upright 402 (shown in FIG. 5). The flat surface 110 is wide enough to stabilize the wire hook 106 from side to side movement while staying within the confines of the gondola upright 402 and not making contact to adjoining surfaces that would skew the hang angles.

A mounting detail 112 of the hook projects outward from the flat surface 110. The width of the mounting detail 112 is slightly less than the width of the openings 404 (shown in FIG. 5) stamped through the uprights 402 (shown in FIG. 5). This allows for the mounting detail 112 to rotate freely to readily facilitate installation and removal of the mounting bracket assembly 100 from the gondola upright 402, while at the same time providing stability against rotation to the left or right.

In a particular embodiment, an upper portion of the mounting detail 112 has standing boss 114 that is spaced apart from the flat surface 110 to which the mounting detail 112 is attached. This spacing controls the hang angle of the mounting bracket assembly 100 and provides the interference that keeps the mounting bracket assembly 100 from being removed without intent. In a particular embodiment, a portion of the standing boss 114 extends below the wire hook 106 (when viewed as shown in FIG. 1) so as to avoid interference from the wire hook 106 when the mounting bracket assembly 100 is installed in the gondola upright 402 (shown in FIG. 5). Another portion of the standing boss 114 extends to a point above the wire hook 106 to establish a flat plane 116 that rests against the inside wall of the gondola upright 402.

Although the mounting detail 112 could be made from molded solid plastic materials, in alternate embodiments, a portion of the mounting detail 112 may be cored out to avoid deforming, dimpling, or sinking of the outer walls of the mounting detail when the molded plastic cools. The height of the mounting detail 112 is made to fit within the heights of the opening 404 in the gondola uprights 402. The bottom back corner of the mounting detail 112 has a large sweeping radius to allow the rotation of the mounting bracket 102 into place and flat portion at the bottom of the mounting detail 112 allows the mounting bracket 102 to rest in the opening 404 of the gondola upright 402. A top portion 118 of the mounting bracket 102 has a flat triangular surface to aid in the stability of the wire hook 106.

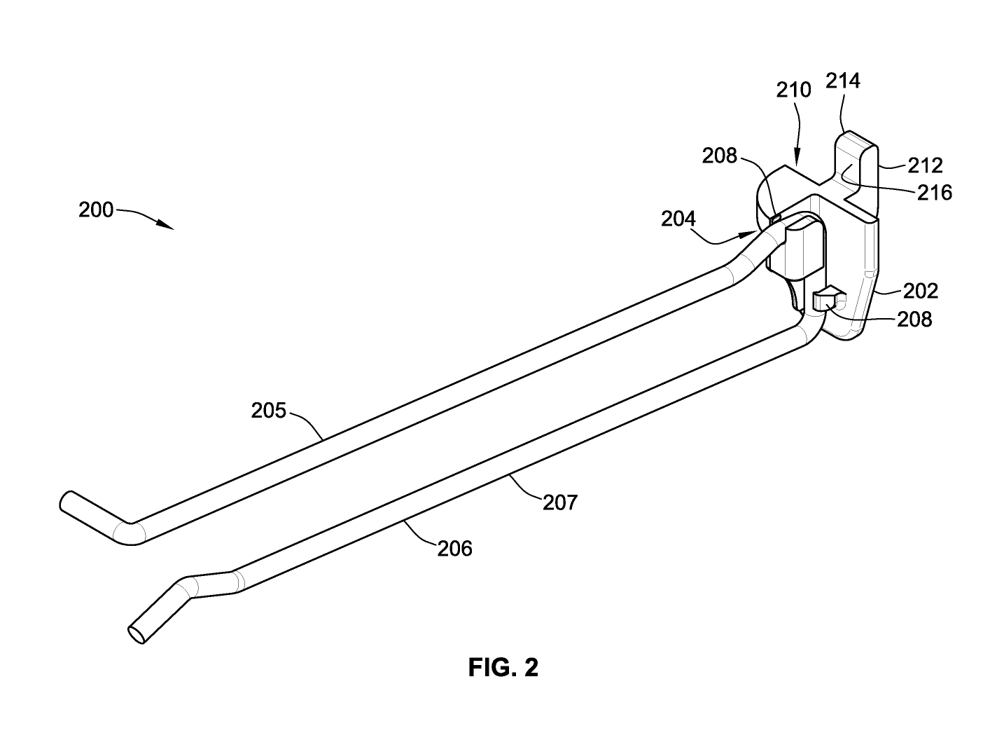

FIG. 2 is a pictorial illustration of a mounting bracket assembly 200, according to an embodiment of the invention. The mounting bracket 202 is designed with a specific contour 204 for the insertion of the wire hook 206. The specific contour has snap points 208 to offer resistance to prevent the wire hook 206 from being removed from the mounting bracket 202. In the embodiment of FIG. 2, the wire hook 206 is roughly U-shaped with an upper wire 205 and a lower wire 207. The specific contour 204 includes multiple flats that make contact with one end of the wire hook 206 to aid in the fit of the wire hook 206 to the mounting bracket 202.

The mounting bracket 202 is designed to maintain an even wall thickness where it can, to avoid sinking and deforming from oversized walls. Behind the mounting area for the wire hook 206 is a flat surface 210 that will come in contact with the gondola upright 402 (shown in FIG. 5). The flat surface 210 is wide enough to stabilize the wire hook 206 from side to side movement while staying within the confines of the gondola upright 402 and not making contact to adjoining surfaces that would skew the hang angle of the mounting bracket assembly 200.

The mounting detail 212 of the wire hook 206 projects outward from the flat surface 210. The width of the mounting detail 212 is slightly less than the width of the opening 404 (shown in FIG. 5) stamped through the gondola upright 402. This allows for the mounting detail 112 to rotate freely to readily facilitate installation and removal of the mounting bracket assembly 200 from the gondola upright 402, while at the same time providing stability against rotation to the left or right.

In a particular embodiment, an upper portion of the mounting detail 212 has a standing boss 214 that is spaced apart from the flat surface 210 to which the mounting detail 212 is attached. This spacing controls the hang angle of the mounting bracket assembly 200 and provides the interference that keeps the mounting bracket assembly 200 from being removed without intent. In a particular embodiment, a portion of the standing boss 114 extends below the wire hook 106 (when viewed as shown in FIG. 1) so as to avoid interference from the wire hook 206 when the mounting bracket assembly 200 is installed in the gondola upright 402 (shown in FIG. 5). Another portion of the standing boss 214 extends to a point above the wire hook 206 to establish a flat plane 216 that rests against the inside wall of the gondola upright 402.

Although the mounting detail 212 could be made from molded solid plastic materials, in alternate embodiments, a portion of the mounting detail 212 may be cored out to avoid deforming, dimpling, or sinking of the outer walls of the mounting detail when the molded plastic cools. The height of the mounting detail 212 is made to fit within the height of the opening 404 in the gondola upright 402. The bottom back corner of the mounting detail 212 has a large sweeping radius to allow the rotation of the mounting bracket 202 into place and then a flat at the bottom for the mounting bracket 202 to rest in the opening 404 of the gondola upright 402. A top portion 218 of the mounting bracket 202 has a flat triangular surface that is there to aid in the stability of the wire hook 206.

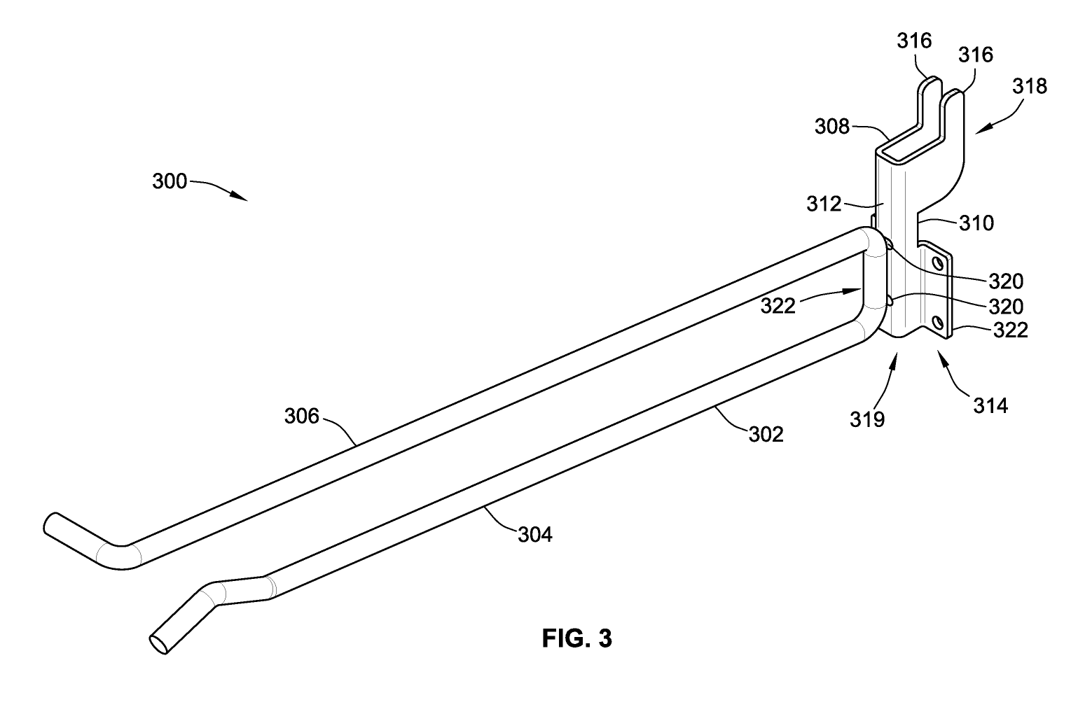

FIG. 3 is a pictorial view of a mounting bracket assembly 300, according to an embodiment of the invention. The scan hook 302 has both a hang wire 304 for supporting retail products and an upper wire 306 that is generally parallel to the hang wire 304. The main purpose of the upper wire 306 is to create an area for the mounting of a label holder (not shown) to the mounting bracket assembly 300. In a particular embodiment, the hang wire 304 and upper wire 306 are made from the same continuous section of wire. In the embodiment of FIG. 3, the scan hook 302 has two 90-degree bends that create a vertical rise between the hang wire 304 and the upper wire 306.

In particular embodiments of the invention, the back, or mounting area, of the mounting bracket 310 is similar to the mounting area of the mounting brackets 102, 202 described above. In a particular embodiment, the scan hook 302 is mounted to a vertical plane or wall 312 by welding or brazing. However, other methods for attaching the scan hook 302 to the vertical wall 312 using adhesives or mechanical fasteners, for example, are also envisioned. While the mounting bracket 310 can be configured such that the scan hook 302 can be welded to the vertical wall 312 of the mounting bracket 310, it is also envisioned that the mounting bracket 310 could be molded from a rigid plastic material.

In the embodiment of FIG. 3, the mounting bracket 310 has two ears 316 spaced such that the width of a mounting detail 318 is slightly less than the width of the openings 404 found in the gondola upright 402 (shown in FIG. 5). The height of the mounting detail 318 is made to fit within the height of the opening 404 (shown in FIG. 5) in the gondola upright 402. The bottom back corner of the mounting detail 318 has a large radius to allow for rotation of the mounting bracket 310 into place within the opening 404. The mounting detail 318 further includes a flat portion at the bottom which allows the mounting bracket 310 to rest securely in the opening 404 of the gondola upright 402.

A lower portion 314 of the mounting bracket 310 includes a strong channel 319 that has weld projections 320 for the use of resistant welding of the scan hook 302 to the mounting bracket 310. In the embodiment of FIG. 3, two flanges 322 extend from each side of the channel 319 in a lateral direction to stabilize the mounting bracket 310 and reduce or prevent both vertical rotation and side to side movement of the mounting bracket 310. In alternate embodiments of the invention, the mounting bracket 310 may have fewer or greater than two flanges.

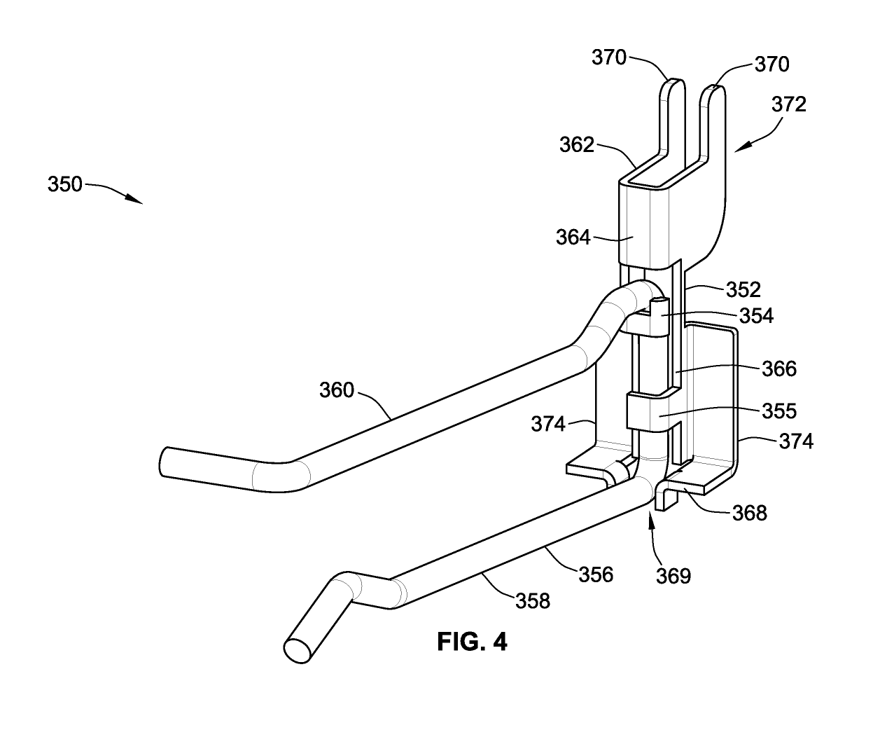

FIG. 4 is a pictorial view of a mounting bracket assembly 350, according to a particular embodiment of the invention. The mounting bracket 352 has two containing areas 354, 355 for capturing and retaining the scan hook 356. The upper containing area 354 is U-shaped and restricts side-to-side movement of the scan hook 356. The upper containing area 354 also restricts downward movement of the scan hook 356. In a particular embodiment, the upper containing area 354 has a notched area in front that creates a snap fit when the scan hook 356 is inserted into the mounting bracket 352.

The lower containing area 355 is generally a U-shaped as well, using a common vertical wall 366 that supports the upper containing area 354. A standing core area 368 with an undercut front edge extends horizontally from lateral flanges 374 and includes a channel 369 to create a containing fit for the scan hook 356. In a particular embodiment, the lower containing area 355 is oriented in an approximately 180-degree rotation from the upper containing area 354. Between these two areas 354, 355, the scan hook 356 is substantially restricted from movement in all three dimensions. The details for attaching the mounting bracket assembly 350 into the gondola upright 402 (shown in FIG. 5) are similar to those of the mounting bracket assembly 300 shown in FIG. 3.

The scan hook 356 has both a hang wire 358 for supporting retail products and an upper wire 360 that is generally parallel to the hang wire 358. The main purpose of the upper wire 360 is to create an area for the mounting of a label holder (not shown) to the mounting bracket assembly 350. In a particular embodiment, the hang wire 358 and upper wire 360 are made from the same continuous section of wire. In the embodiment of FIG. 4, the scan hook 356 has two 90-degree bends that create a vertical rise between the hang wire 358 and the upper wire 360.

The mounting bracket 352 has two ears 370 spaced such that the width of a mounting detail 372 is slightly less than the width of the openings 404 (shown in FIG. 5) found in the gondola upright 402 (shown in FIG. 5). The height of the mounting detail 372 is made to fit within the height of the opening 404 in the gondola upright 402. The bottom back corner of the mounting detail 372 has a large radius to allow for rotation of the mounting bracket 352 into place within the opening 404. The mounting detail 372 further includes a flat at the bottom which allows the mounting bracket 352 to rest securely in the opening 404 of the gondola upright 402.

In the embodiment of FIG. 4, two lateral flanges 374 extend from each side of the common vertical wall 366 in a lateral direction to stabilize the mounting bracket 352 and reduce or prevent both vertical rotation and side to side movement of the mounting bracket 352. In alternate embodiments of the invention, the mounting bracket 352 may have fewer or greater than two flanges.

In a particular embodiment, the mounting detail 372 comprises a U-shaped portion 362. The width of this U-shaped portion 362 restricts movement of the mounting detail 372, and therefore the mounting bracket 352, from side to side within opening 404 (shown in FIG. 5). Further, the U-shaped portion 362 includes a vertical plane or wall 364 to restrict vertical movement of the scan hook 356 in the mounting bracket 352.

In a particular embodiment, the mounting bracket 352 is created from a metal stamping, an example of which is provided by the R36 mounting bracket 352 manufactured by Southern Imperial Inc. of Rockford, Ill. In alternate embodiments of the invention, the mounting bracket 352 is made from molded plastic.

FIG. 4 shows a pictorial view of a gondola upright 402 incorporating each of the mounting bracket assemblies 100, 200, 300 described above. The gondola upright 402 supports one side of peg board 406. Each of the mounting bracket assemblies 100, 200, 300 fits into one of the plurality of openings 404 in the gondola upright 402. Thus, a single gondola upright can support a variety of mounting bracket assemblies, including the embodiments described herein. As such, retail items which previously could only be displayed from mounting system supported between gondola uprights using the peg board 406, for example, can be displayed prominently from any single gondola upright 402. It is also envisioned that embodiments of the invention described herein could be used to the mounting of various retail items such as aisle markers and/or signage.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A mounting bracket assembly for a gondola upright comprising;
a mounting bracket having a mounting detail and a substantially flat portion;
a wire hook configured to be attached to the mounting bracket;
wherein the mounting detail is configured to fit into an opening in the gondola upright, the mounting detail configured to secure the mounting bracket to the gondola upright, and wherein the substantially flat portion is configured to position the mounting bracket and wire hanger in a desired orientation.

2. The mounting bracket assembly of claim 1, wherein the wire hook comprises a hanger wire positioned below an upper wire.

3. The mounting bracket assembly of claim 1, wherein the hanger wire is configured to support retail items and the upper wire is configured to support signage.

4. The mounting bracket assembly of claim 3, wherein the wire hook includes a vertical portion with two 90-degree bends, and wherein the wire hook is secured to the mounting bracket via two U-shaped containing areas.

5. The mounting bracket assembly of claim 1, wherein the mounting bracket is a metal stamping.

6. The mounting bracket assembly of claim 1, wherein the mounting bracket is made from molded plastic.

7. The mounting bracket assembly of claim 1, wherein the wire hook is press fit into the mounting bracket.

8. The mounting bracket assembly of claim 1, wherein the wire hook is attached to the mounting bracket by welding or brazing.

9. The mounting bracket assembly of claim 1, wherein the substantially flat portion comprises one or more laterally-extending flanges.

10. The mounting bracket assembly of claim 1, wherein the mounting detail projects out and away from the substantially flat portion, and further includes a vertically upward-extending portion.

11. The mounting bracket assembly of claim 1, wherein the mounting detail has two ears spaced such that the width of a mounting detail is slightly less than the width of the opening in the gondola upright.

12. A retail display system comprising:
one or more gondola uprights configured to support the retail display system;
a mounting bracket assembly capable of being mounted in a single gondola upright, the mounting bracket assembly comprising:
a mounting bracket having a mounting detail and a substantially flat portion;
a wire hook configured to be attached to the mounting bracket;
wherein the mounting detail is configured to fit into an opening in the gondola upright, the mounting detail configured to secure the mounting bracket to the gondola upright, and wherein the substantially flat portion is configured to position the mounting bracket and wire hanger in a desired orientation.

13. The retail display system of claim 12, wherein the wire hook comprises a hanger wire positioned below an upper wire.

14. The retail display system of claim 12, wherein the hanger wire is configured to support retail items and the upper wire is configured to support signage.

15. The retail display system of claim 14, wherein the wire hook includes a vertical portion with two 90-degree bends, and wherein the wire hook is secured to the mounting bracket via two U-shaped containing areas.

16. The retail display system of claim 12, wherein the mounting bracket is a metal stamping.

17. The retail display system of claim 12, wherein the mounting bracket is made from molded plastic.

18. The retail display system of claim 12, wherein the wire hook is press fit into the mounting bracket.

19. The retail display system of claim 12, wherein the wire hook is attached to the mounting bracket by welding or brazing.

20. The retail display system of claim 12, wherein the substantially flat portion comprises one or more laterally-extending flanges.

21. The retail display system of claim 12, wherein the mounting detail projects out and away from the substantially flat portion, and further includes a vertically upward-extending portion.

22. The retail display system of claim 12, wherein the mounting detail has two ears spaced such that the width of a mounting detail is slightly less than the width of the opening in the gondola upright.
